(19) United States
(12) Patent Application Publication
(10) Pub. No.: US 2016/0328642 A1
(43) Pub. Date: Nov. 10, 2016

(54) SENSOR SIGNAL PROCESSING USING AN ANALOG NEURAL NETWORK

(71) Applicant: Indiana University Research and Technology Corporation, Indianapolis, IN (US)

(72) Inventors: Bryce D. Himebaugh, Bloomington, IN (US); Gregory W. Mattes, Nashville, TN (US); Kenichi Yoshida, Carmel, IN (US); Michael J. Bertram, Indianapolis, IN (US)

(21) Appl. No.: 15/148,706

(22) Filed: May 6, 2016

Related U.S. Application Data
(60) Provisional application No. 62/157,823, filed on May 6, 2015.
(60) Provisional application No. 62/196,612, filed on Jul. 24, 2015.

(51) Int. Cl. G06N 3/063; G06F 1/32; G06N 3/08

(52) U.S. Cl. CPC G06N 3/0635; G06N 3/084; G06F 1/3296

(57) ABSTRACT

The present disclosure relates to sensor signal processing using an analog neural network. In an embodiment, a sensor signal processing system comprises: an analog neural network communicatively coupled to at least one sensor and a digital processor communicatively coupled to the analog neural network. The analog neural network is configured to receive a plurality of analog signals wherein the plurality of analog signals are associated with a plurality of sensor signals output by the at least one sensor. The analog neural network also determines an analog signal of the plurality of analog signals that is indicative of an event of interest and generates an activation signal to the digital processor in response to determining an analog signal is indicative of an event of interest. The digital processor is configured to receive the activation signal and transition to a higher-power state from a lower-power state in response to the activation signal.

### CROSS-REFERENCE TO RELATED APPLICATIONS

This application claims the benefit under 35 U.S.C. §119(e) of U.S. Provisional Application Ser. No. 62/157,823, entitled “Sensor Signal Processing Systems and Methods Featuring an Analog Neural Network,” filed on May 6, 2015 and U.S. Provisional Application Ser. No. 62/196,612, entitled “Sensor Signal Processing Systems and Methods Featuring an Analog Neural Network,” filed on Jul. 24, 2015, both of which are incorporated herein by reference in their entireties.

### GOVERNMENT INTEREST

Certain embodiments disclosed herein were made with the support of the U.S. Government under Contract IIP-1417062 between the National Science Foundation and Analog Computing Solutions, Inc. The U.S. Government has certain rights in the embodiments disclosed herein.

### COPYRIGHT STATEMENT

A portion of this application contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE DISCLOSURE

The present disclosure relates to sensor signal processing systems and methods featuring an analog neural network in communication with one or more sensors and a digital processor.

### BACKGROUND

It is common in many fields to monitor processes or the functioning of devices using one or more sensors. As used herein, a process is any electrical, mechanical, optical, chemical, biological, or combination thereof which has aspects or parameters which can be sensed and reduced to data by a sensor. A device is any apparatus, machine, system, hardware or software stored on memory. A sensor may function utilizing known electrical, magnetic, optical, chemical or mechanical principles and provide sensed data in the form of, for example, an optical or electrical output signal. In most modern sensor-based systems, the sensor output signal is monitored using a controller, monitor, circuit or other processing element incorporating a digital processor. The digital processor performs various functions based upon data received from the sensor(s). Processes performed or initiated by a digital processor may include, but are not limited to, data analysis, data logging, data storage, process or system control, alarm functionality and the like.

For example, an industrial furnace control processor receiving temperature data from a temperature sensor may actively control the pumps and valves necessary to set a desired fuel flow rate in response to a sensed temperature. The processor may also perform other functions, for example temperature logging, system status reporting, alarm generation and so forth based upon the sensor data input to the digital processor.

Certain processes are highly dynamic and therefore require continuous sensing plus continuous or near-continuous processor control activity. Other processes are relatively stable. The signal provided from a sensor associated with a relatively stable process may vary only slightly within selected parameters over extended periods of time. For example, a sensor which detects the failure of a durable mechanical part may return data for many days, weeks or years indicative of normal operation. Only at the critical point in time, when the sensed part fails, would the sensor data vary significantly from a normal baseline.

Powering a typical digital processor to monitor a system sensing a relatively stable process or where the timing of the sensed event is unknown wastes energy. In addition, with certain types of systems (typically widely distributed or wireless embedded sensing systems) sufficient power is not readily available at the sensing site to continuously power a digital processor or to continuously power data transmission from the sensor(s) to a digital processor. Thus, in these instances, batteries and energy scavenging technologies are relied upon to power both the sensor(s) and any associated processor. Typically, batteries and energy scavenging technologies cannot provide sufficient power to continuously operate a digital processor and an associated sensor network for an extended period of time. Thus, digital systems may rely upon power saving techniques such as intermittent sensing, data rate reduction and processor sleep and/or hibernation states, all of which introduce the risk that potentially valuable data will be missed or a critical action will be delayed. Hence, there exists a need for sensor systems and methods that reduce energy usage.

### SUMMARY

The embodiments disclosed herein present a possible solution to needs identified above. In an embodiment, a sensor signal processing system comprises: an analog neural network communicatively coupled to at least one sensor, the analog neural network being configured to: receive a plurality of analog signals, the plurality of analog signals being associated with a plurality of sensor signals output by the at least one sensor; determine an analog signal of the plurality of analog signals that is indicative of an event of interest; and generate an activation signal in response to determining an analog signal is indicative of an event of interest; and a digital processor communicatively coupled to the analog neural network, the digital processor being configured to: receive the activation signal; and transition to a higher-power state from a lower-power state in response to the activation signal.

In another embodiment, a method of processing a sensor signal comprises: receiving, by an analog neural network, a plurality of analog signals, the plurality of analog signals being associated with a plurality of sensor signals output by at least one sensor; determining, by the analog neural network, an analog signal of the plurality of analog signals that is indicative of an event of interest; and sending, by the analog neural network, an activation signal to a digital processor for each analog signal that is determined to be indicative of an event of interest, the activation signal initiating a transition of the digital processor to a high-power state from a lower-power state.

In even another embodiment, a circuit comprises: at least one sensor input communicatively coupled to at least one sensor output of at least one sensor; at least one memory input communicatively coupled to an external memory device; at least one digital processor output communicatively coupled to at least one digital processor input of a digital processor; an analog neural network being configured to: receive, via the at least one sensor input, a plurality of analog signals, the plurality of analog signals being associated with a plurality of sensor signals output by the at least one sensor; load, via the at least one memory input, a plurality of weights; determine an analog signal of the plurality of analog signals that is indicative of an event of interest using the plurality of weights; and send, via the at least one digital processing output, an activation signal to the digital processor in response to determining an analog signal is indicative of an event of interest, the activation signal initiating a transition of the digital processor to a higher-power state from a lower-power state.

As the terms are used herein with respect to ranges of measurements (such as those disclosed immediately above), “about” and “approximately” may be used, interchangeably, to refer to a measurement that includes the stated measurement and that also includes any measurements that are reasonably close to the stated measurement, but that may differ by a reasonably small amount such as will be understood, and readily ascertained, by individuals having ordinary skill in the relevant arts to be attributable to measurement error, differences in measurement and/or manufacturing equipment calibration, human error in reading and/or setting measurements, adjustments made to optimize performance and/or structural parameters in view of differences in measurements associated with other components, particular implementation scenarios, imprecise adjustment and/or manipulation of objects by a person or machine, and/or the like.

As used herein, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Although the term “block” may be used herein to connote different elements illustratively employed, the term should not be interpreted as implying any requirement of, or particular order among or between, various steps disclosed herein unless and except when explicitly referring to the order of individual steps. Additionally, a “set” or “group” of items (e.g., inputs, algorithms, data values, etc.) may include one or more items, and, similarly, a subset or subgroup of items may include one or more items.

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

### BRIEF DESCRIPTION OF THE DRAWINGS

FIG. 1 is a block diagram depicting an illustrative sensor signal processing system using an analog neural network, in accordance with embodiments of this disclosure.

FIG. 2 is a schematic diagram depicting a portion of an illustrative sensor signal processing system using an analog neural network, in according with embodiments of this disclosure.

FIG. 3 is a flow diagram depicting an illustrative sensor signal processing method using an analog neural network, in accordance with embodiments of this disclosure.

FIG. 4 is a block diagram depicting an illustrative analog system using an analog neural network, in accordance with embodiments of this disclosure.

FIG. 5 is a flow diagram depicting the process of the illustrative analog neural network circuit depicted in FIG. 4.

FIG. 6 is a block diagram depicting an illustrative example of a medical sensor signal processing system using an analog neural network, in accordance with embodiments of this disclosure.

FIG. 7 is a flow diagram depicting the process of the illustrative example of a sensor signal processing system depicted in FIG. 6.

FIG. 8 is a flow diagram depicting a method for using an analog neural network in a machine that includes one or more rotating parts, in accordance with embodiments of this disclosure.

FIG. 9 is a flow diagram depicting a method for using an analog neural network in an engine, in accordance with embodiments of this disclosure.

While the disclosed subject matter is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

The embodiments disclosed herein include an analog neural network that is communicatively coupled to a sensor(s) and a digital processor. In general, the analog neural network consumes less power than the digital processing device. In some circumstances, however, a system may need the processing power of the digital processor. As such, it is sometimes advantageous for the analog neural network to be operating while the digital processor is in a lower-power state and it is sometimes advantageous for the digital processor to operate in a higher-power state to perform processing functions. To do so, the analog neural network continuously, or near continuously, processes signals associated with the output of the sensor. If the analog neural network determines an event of interest has occurred when processing signals associated with the output of the sensor, the analog neural network generates an activation signal that is received by the digital processor. In response to receiving the activation signal, the digital processor transitions from a lower-power state to a higher-power state. An event of interest, as used herein, may be an operation and/or occurrence of a mechanical, electrical, optical, chemical and/or biological system that a sensor senses that is a significant event for the system and/or not part of the normal operation of the system. The digital processor, operating in a higher-power state may then be utilized for further data processing, system control, data communication, and/or data storage once an event of interest is determined.

Reducing the active duration of the digital processor reduces overall system power consumption and, can therefore, extend the useful life and/or the battery life of the system. This may be especially advantageous for systems that are remote and/or difficult to access. For example, the disclosed systems and methods may be particularly useful for mobile, wireless and/or distributed sensor applications. In addition, the described systems and methods can reduce data communication and data storage requirements.

Due to the advantages described above, the systems and methods described herein may be particularly useful for sensing systems where relatively lengthy periods of time may pass between events of interest. The described systems and methods, however, may be implemented within any system where sensor output may be processed by a digital processor.

### General Systems and Methods

In many types of embedded sensor-based systems, sensors operating on electrical, magnetic, chemical, mechanical, optical or a combination of principles provide information about the surrounding environment. The output of a typical sensor is a time varying analog signal or in certain cases a digital signal. Many sensor-based systems require a small form factor and have sensors located in remote or difficult to access locations. Accordingly, many systems require battery and/or power scavenging technologies as a source of operational power. These limited power sources can limit the operational usefulness of an embedded sensor-based system.

The systems and methods disclosed herein provide for continuous, or near continuous, monitoring of sensor data using an analog neural network that can detect events of interest. The analog neural network is in further communication with a digital processor. This system configuration allows the digital processor to remain in a lower-power state (e.g., a sleep and/or hibernation state) while the analog neural network provides for the continuous or near continuous monitoring of sensor data. When the analog circuit detects an event of interest, the digital processor may be activated to perform additional processing, system control, data communication, and/or data storage.

Significant power savings occur because of the nature of digital signal processing. In particular, to process a complex analog signal, a digital processor must operate in a high power mode. Inserting a low power analog circuit before the digital processor to classify signals as either events of interest or events of non-interest, prior to activating the digital processor, allows the digital processor to stay in a low-power state for a higher percentage of time. This has the effect of significantly lowering the overall system power usage.

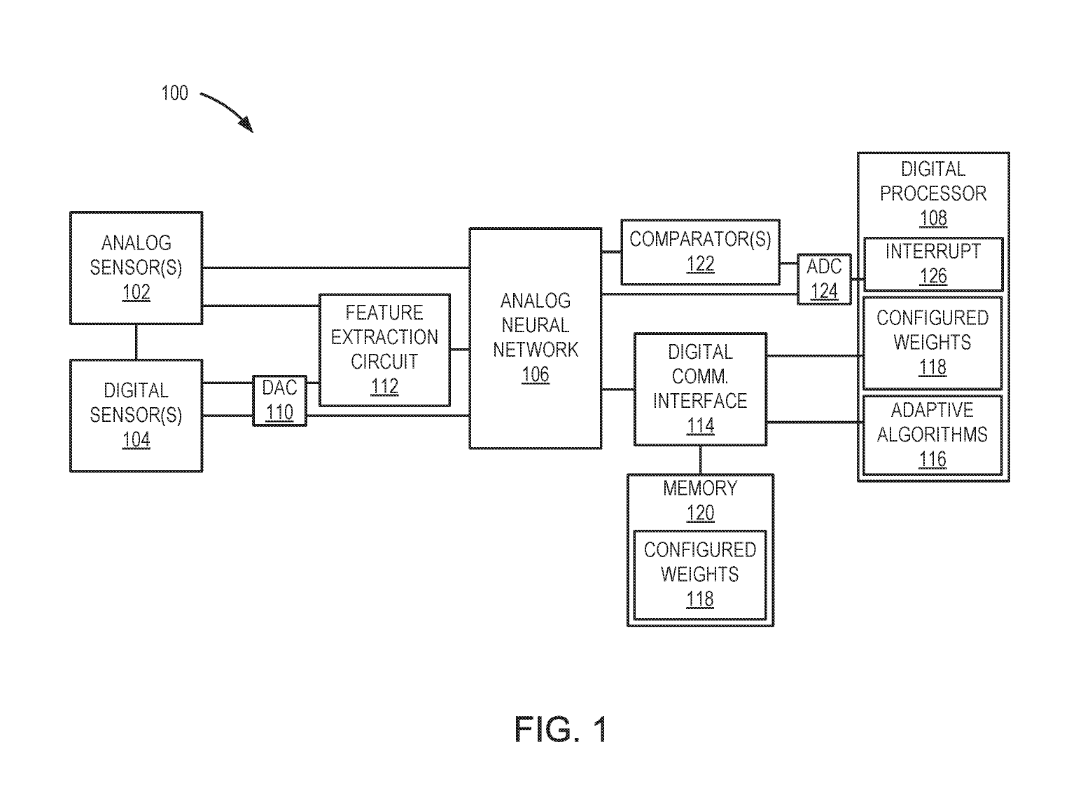

FIG. 1 is a block diagram depicting an illustrative sensor signal processing system 100 using an analog neural network, in accordance with embodiments of this disclosure. The system 100 includes one or more sensors 102, 104, an analog neural network 106 and a digital processor 108. The analog neural network 106 is communicatively coupled to the sensors 102, 104 in order to receive analog signals associated with sensor signals output by the sensors 102, 104. An analog signal may be associated with a sensor signal if the analog signal is the sensor signal and/or corresponds to one or more features of the sensor signal, as discussed in more detail below. Using the analog signals, the analog neural network 106 determines whether an event of interest has been sensed by the sensors 102, 104. Further, the analog neural network 106 outputs an analog signal indicative of whether an event of interest has been sensed by the sensors 102, 104. If the analog neural network 106 determines an event of interest has been sensed by the sensors 102, 104, the analog signal output by the analog neural network 106 is sent to the digital processor 108, which initiates an activation of the digital processor 108 from a lower-power state to a higher-power state.

While the analog neural network 106 and the digital processor 108 are shown to be separate components, in embodiments, they may be integrated together, for example, fabricated on the same integrated circuit die. In other embodiments, such as the one illustrated, the analog neural network 106 may be separate from the digital processor 108 but the two are communicatively coupled.

The analog neural network 106 may be communicatively coupled to the sensors 102, 104 and digital processor 108 either directly or indirectly (for example, via another component as described below) via a wired or wireless connection. Wireless connections may include, for example, a short-range radio link, such as Bluetooth, IEEE 802.11, a proprietary wireless protocol, and/or the like. In embodiments, the sensors 102, 104 may communicate with the analog neural network 106 via a Bluetooth Low Energy radio (Bluetooth 4.1), or a similar protocol, and may utilize an operating frequency in the range of 2.40 to 2.48 GHz.

The sensors 102, 104 may be incorporated into a variety of different systems including, but not limited to, medical devices, navigation devices, consumer electronics, vehicle components (including, e.g., engines, transmissions, wheels, etc.) and/or the like, in order to sense a variety of different types of electrical, optical, mechanical, chemical and/or biological properties. The specific types of sensors 102, 104 used in a given system may be application specific. For example, application-specific sensors 102, 104 may include, but are not limited to, electroneurographic (ENG) sensors, electromyographic (EMG) sensors, electrocardiographic (ECG) sensors, accelerometers, gyroscopes, magnetometers, pressure sensors, photodiodes, temperature sensors, humidity and moisture sensors, sensors configured to detect one or more chemicals and sensors capable of sensing other physiological parameters.

The sensors 102, 104 may be standalone devices or implemented as part of an embedded sensor network, that may or may not be coordinated with one another, in order to measure different aspects of a mechanical, electrical, optical, chemical and/or biological system. As illustrated in FIG. 1, the sensors 102, 104 may include analog sensors 104 and/or digital sensors 106. In embodiments, outputs of the digital sensors 104 may be sent to the analog neural network 106 via a digital-to-analog converter (DAC) 110.

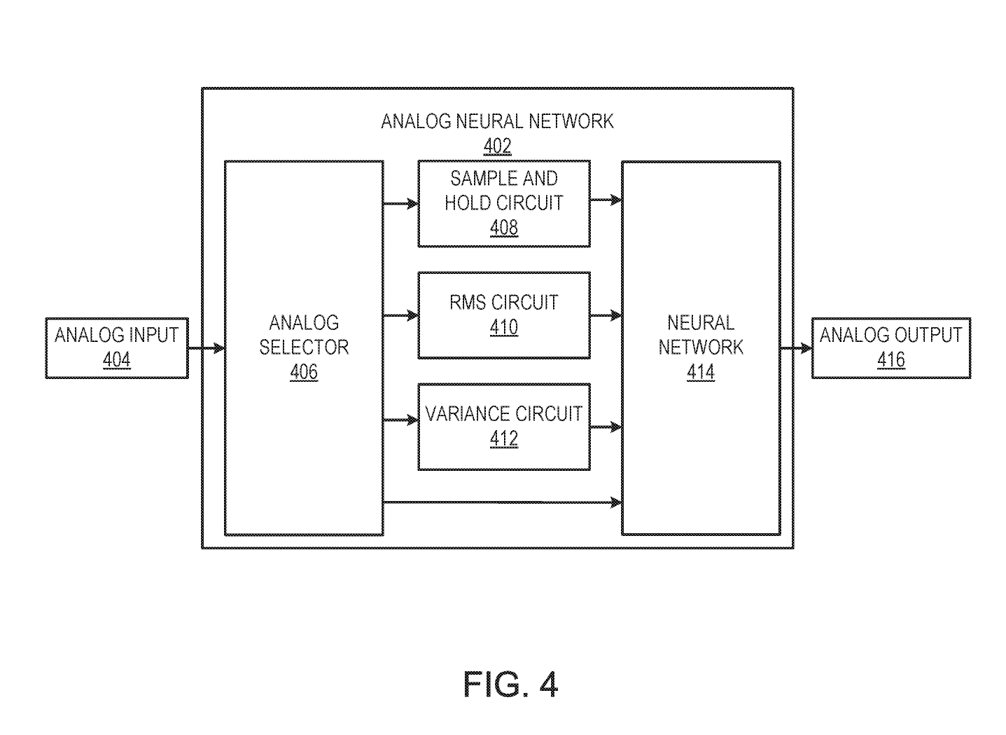

In embodiments, instead of receiving sensor signals directly from the sensors 102, 104, a feature extraction circuit 112 may be positioned between the sensors 102, 104 and the analog neural network 106. While the feature extraction circuit 112 is shown separate from the analog neural network 106, in embodiments, the feature extraction circuit 112 may be incorporated into the analog neural network 106. Thus, the functionality described herein with respect to the feature extraction circuit 112 may be implemented within a separate analog feature extraction module as shown in FIG. 1 or may be directly implemented within the analog neural network 102 as shown in FIG. 4. Further, while the sensor signals output from the digital sensors 104 are shown to be converted to analog signals before being received by the feature extraction module 112, alternatively, the feature extraction circuit 112 may receive digital signals and extract features therefrom.

In embodiments, the feature extraction circuit 112 may be provided with the ability to calculate the root-mean-square (RMS) of sensor signals over a given time period. The RMS value can then be sent to the analog neural network 106 for processing. Additionally or alternatively, the feature extraction circuit 112 may calculate the statistical measure of the spread of a multitude of sensor signals around a mean over a given time period, i.e., the variance of one or more sensor signals with respect to a mean. This or other values can be presented to the analog neural network 106 for processing. Other known statistical processing methods may be used to extract features from the sensor signals output by the sensors 102, 104.

Additionally or alternatively, supplemental analog signal processing may be performed on the sensors signals prior to being received by the analog neural network 106. Additional processing may include, but is not limited to, signal amplification, buffering, filtering, and/or multiplexing sensor signals from multiple sensors 102, 104.

In embodiments, the feature extraction circuit 112 may be include sample and hold functionality. Thus, the feature extraction circuit 112 may include the ability to sample an analog/digital value of an analog/digital sensor signal at a particular point in time and hold that value before sending the value to the analog neural network 106 for processing. In embodiments, multiple feature extraction circuits 112 including the ability to sample and hold digital/analog values may be connected in series such that a time series of values can be presented to the analog neural network 106. The time between samples may be controlled by an external clock (not shown). In embodiments, the sample and hold functionality may be used for analog waveform shape detection using any applicable technique. While sample and hold functionality is discussed in relation to the feature extraction circuit 112, alternatively, the sample and hold functionality may be implemented in other components of the system 100 and/or a component not shown that is not the feature extraction circuit 112.

Once sensor signals are output from the sensors 102, 104, they are received either directly or indirectly (e.g., via the DAC 110 and/or feature extraction circuit 112) by the analog neural network 106. The signals received by the analog neural network 106 are analog signals that may be either the direct output of an analog sensor 102 and/or may correspond to one or more features of an output of the sensors 102, 104. For example, when signal processing (e.g., feature extraction) is performed on the sensor signals, before being received by the analog neural network 106, the analog neural network 106 will receive analog signals corresponding to one or more features of the sensor signals output by the sensors 102, 104

In embodiments, the analog neural network 106 is a multi-layer neural network that can be configured to determine a variety of events of interest. That is, the analog neural network 106 may be configured to identify one or more events of interest by adjusting the weights, during a training period, that are applied to the neurons included in the analog neural network 106. For example, during a training period, analog signals corresponding to an event of interest and analog signals corresponding to an event of non-interest may be input into the analog neural network 106. After the neurons included in the analog neural network 106, and weights applied thereto, process the inputted analog signals, the analog neural network 106 will output an analog signal. If the analog signal that is output is not the desired output, the weights applied to the neurons are adjusted so that the analog neural network 106 outputs a desired analog signal. For example, when analog signals corresponding to an event of interest are received by the analog neural network 106, a desired analog output by the analog neural network 106 may be, for example, a non-zero voltage (e.g., 1V) and, as such, the weights applied to neurons are adjusted until the analog neural network 106 outputs such an analog signal. Alternatively, as another example, when analog signals corresponding to an event of non-interest are received by the analog neural network 102, a desired analog output by the analog neural network 102 may be, for example, approximately a zero voltage (e.g., 0V+/−10%) and, as such, the weights applied to the neurons are adjusted until the analog neural network 106 outputs such an analog signal.

In embodiments, the analog neural network 106 may determine whether an event of interest has occurred and output corresponding analog signals continuously or near continuously, which allows the digital processor 108 to remain inactive or otherwise in a low-power state until an event of interest has been determined. As such, devices that incorporate the system 100 therein operate in an energy efficient manner thus increasing implementation possibilities, extending device battery life and providing other benefits.

In embodiments, the digital processor 108 may be used to configure the analog neural network 106, via a digital communication interface 114, using one or more adaptive algorithms 116. That is, the adaptive algorithms 116, during a configuration period, adjust the weights applied to the neurons of the analog neural network 106 to elicit specific analog outputs, when the analog neural network 106 is presented with analog signals indicative of events of interest and events of non-interest. In embodiments, the analog neural network 106 can be configured either in real-time or before deployment of the system 100 for a particular sensing application. In embodiments, the adaptive algorithms 116 may include, but are not limited to, back-propagation algorithms and weight perturbation algorithms. In embodiments, the adaptive algorithms 116 may vary depending on the application. In embodiments, the digital communication interface 114 can be implemented with any suitable interface technology including but not limited to I2C, CAN serial peripheral interface (SPI) and the like.

After the analog neural network 106 is configured to have the appropriate weights, the configured weights 118 can be stored by the digital processor 108 and/or on external memory 120. Alternatively, the configured weights 118 may be stored on the analog neural network 106. In embodiments, the memory 120 may take the form of any non-volatile memory including, but not limited to, EEPROM, FLASH, ROM, SRAM and/or the like.

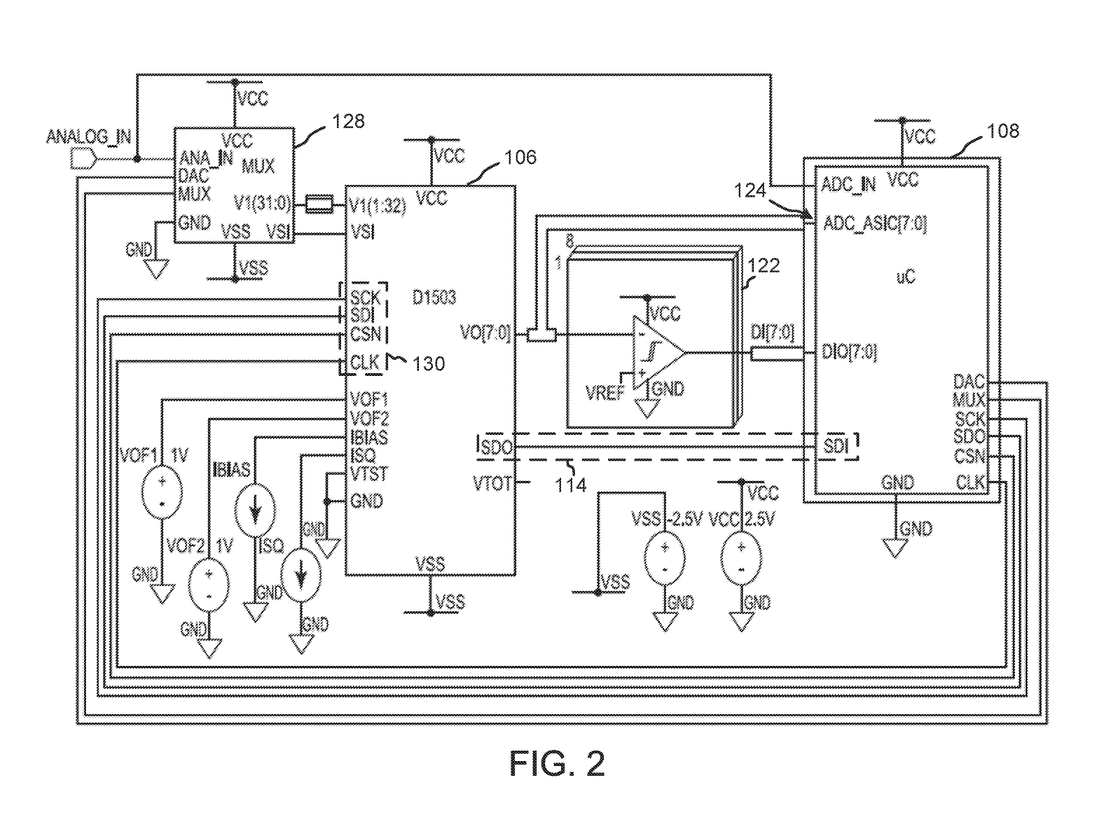

When the configured weights 118 are not stored on the analog neural network 106, the analog neural network 106 may be provided with the ability to retrieve and/or receive these weights 118 either from the digital processor 108 and/or from the memory 120. In embodiments, the digital processor 108 will typically load the entire analog circuit configuration, including the configured weights 118, through the digital communication interface 114 before the analog neural network 106 begins determining events of interest. In embodiments, the contents of the memory in the analog neural network 106 can be read back by the digital processor 108, via the same port of the analog neural network 106 used to load the configured weights 118, to ensure the configured weights 118 have been loaded correctly and/or in full. In embodiments, the digital processor 108 may also update the configured weights 118 and/or the weights loaded onto the analog neural network 106 during training loops, which could be implemented with a feedback loop from the digital processor 108 and a multiplexer (see FIG. 2, 128) on one or more inputs (see FIG. 2, 130) of the analog neural network 106.

After the configured weights 118 are loaded onto the analog neural network 106, the analog neural network 106 may begin receiving analog signals associated with the sensor signals output by the sensors 102, 104. When receiving one or more analog signals, the analog neural network 106 determines whether the received analog signal is indicative of an event of interest by determining the similarity of the received analog signal and one or more analog signals that correspond to an event of interest. As described above, the configured weights 118 loaded on to the analog neural network 106, and applied to the neurons of the analog neural network 106, will elicit an analog output that is, for example, a non-zero voltage if a received analog signal is similar to an analog signal that corresponds to an event of interest. If a received analog signal is not similar to an analog signal indicative of an event of interest, the configured weights 118 will elicit an analog output that is, for example, approximately a zero voltage.

In embodiments, the system 100 may also include one or more comparator modules 122 operatively positioned between the analog neural network 106 and the digital processor 108. The comparator 122 may provide for evaluation of the output of the analog neural network 106 to determine if there is analog signal indicative of an event of interest. The comparator 122, which may be incorporated into the analog neural network 106 may then convert the outputted analog signal to a digitally readable value for input to the digital processor 108. The comparator 122 may be provided with an adjustable threshold to select or set an acceptable range of signals which are similar but not identical to training signals to be recognized. Additionally or alternatively, an analog-to-digital converter 124 may be operatively positioned between the digital processor 108 and the analog neural network 106.

If the analog neural network 106 outputs an analog signal indicative of event of interest sensed by the sensors 102, 104, then the outputted analog signal is received by the digital processor 108 and an interrupt 126 is triggered. The interrupt 126 initiates a conversion of the digital processor 108 from a lower-power state to a higher-power state. For example, the interrupt 126 may convert the digital processor 108 from a sleep and/or hibernation state to a state where the digital processor 108 is capable of performing higher-level processing than when the digital processor 108 is in its sleep and/or hibernation state. In the higher-power state, the digital processor 108 may perform various functions including, but not limited to, system control, data communication, verifying an analog signal is indicative of an event of interest, and/or data storage.

FIG. 2 is a schematic diagram depicting a portion of an illustrative sensor signal processing system circuit using an analog neural network 106, in accordance with embodiments of this disclosure. Like reference numbers depicted in FIGS. 1 and 2 indicate like components that function similarly. As illustrated, FIG. 2 depicts the analog neural network 106, the digital processor 108, digital communication interface 114, comparator 122 and ADC 124 that were depicted and described in FIG. 1. Additionally, FIG. 2 depicts a multiplexer 128 and inputs 130 of the analog neural network 106 that were described above in FIG. 1, but not depicted.

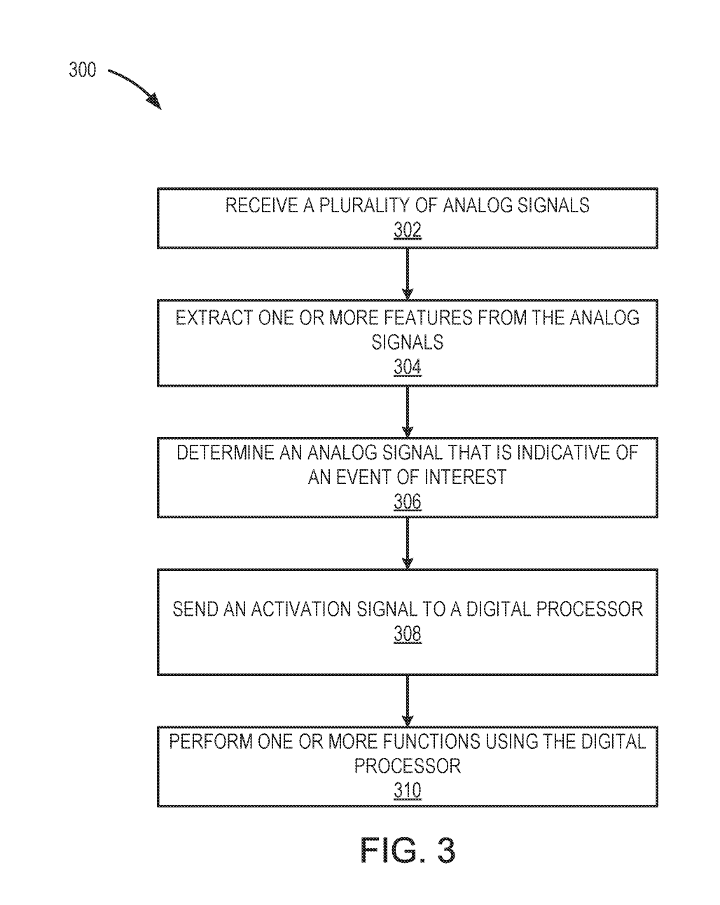

FIG. 3 is a flow diagram depicting an illustrative sensor signal processing method 300 using an analog neural network, in accordance with embodiments of this disclosure. The method 300 includes receiving a plurality of analog signals (block 302). As described above, the analog signals are associated with sensor signals output by one or more sensors (e.g., the sensors 102, 104 of FIG. 1). For example, the analog signals may be analog signals directly output from an analog sensor (e.g., the analog sensor 102 of FIG. 1), an analog signal that was converted from a digital signal output by a digital sensor (e.g., the digital sensor 104 of FIG. 1) and/or a feature of a sensor signal (e.g., the sensor signal output by either the analog sensor 102 or digital sensor 104 depicted in FIG. 1). The sensors outputting the sensor signals associated with the analog signals may be application-specific and may include, but are not limited to, electroneurographic (ENG) sensors, electromyographic (EMG) sensors, electrocardiographic (ECG) sensors, accelerometers, gyroscopes, magnetometers, pressure sensors, photodiodes, temperature sensors, humidity and moisture sensors, sensors configured to detect one or more chemicals and sensors capable of sensing other physiological parameters.

In embodiments, the method 300 also includes extracting one or more features from the received analog signals (block 304). In embodiments, the feature may be an RMS value, a variance, a sampled value from a sensor signal and/or the like.

After receiving the analog signals and possibly extracting one or more features from the received analog signals, the method 300 includes determining an analog signal that is indicative of an event of interest of the received plurality of analog signals (block 306). This determination is made using an analog neural network (e.g., the analog neural network 106 depicted in FIG. 1). That is, the analog neural network applies one or more weights to the neurons included in the analog neural network. The weights are configured using one or more adaptive algorithms (e.g., the adaptive algorithms 116 of FIG. 1) so that when an analog signal indicative of an event of interest is received, the analog neural network will output an analog signal indicating that an analog signal corresponding to an event of interest has been received.

After a determination has been made that an analog signal has been received that corresponds to an event of interest, an activation signal is sent to a digital processor (block 308). The activation signal, which may be a non-zero voltage initiates an activation of the digital processor from a lower-power state (e.g., a sleep and/or hibernation state) to a higher-power state (e.g., a state where the digital processor is capable of functioning at its total capacity). After the digital processor transitions to a higher-power state, the digital processor may perform one or more functions (block 310). For example, the digital processor may perform various functions including, but not limited to, system control, data communication, verifying an analog signal is indicative of an event of interest, and/or data storage.

FIG. 4 is a block diagram depicting an illustrative analog neural network 402, in accordance with embodiments of this disclosure. In the illustrative example, the analog neural network 402 can have the same or similar functionality to the analog neural network 106 depicted in FIG. 1. As illustrated, the analog neural network 402 receives an analog input 404. In embodiments, the analog input 404 is received by an analog selector 406 included in the analog neural network 402. In embodiments, the analog selector 406 can send the analog signal to different components of the analog neural network 402, including a sample and hold circuit 406, an RMS circuit 410, a variance circuit 412 or to the neural network 414 of the analog neural network 402.

As described above, the sample and hold circuit 406 includes the ability to sample an analog value of the analog input 404 at a particular point in time and hold that value before sending the value to the neural network 414 for processing. In embodiments, multiple sample and hold circuits 408 may be connected in series such that a time series of values of the analog input 404 can be presented to the neural network 414. The time between samples may be controlled by an external clock (not shown). In embodiments, the sample and hold circuit 408 may be used for analog waveform shape detection using any applicable technique. Additionally or alternatively, the RMS value of the analog input 404 can be determined by the RMS circuit 410 and the variance of the analog input 404 can be determined with respect to a mean by variance circuit 412 and sent to the neural network 414. In other embodiments, the analog input 404 may be sent directly to the neural network 414, bypassing the circuits 408, 410, 412. After the neural network 414 either receives a signal from one of the circuits 408, 410, 412 or the analog input 404 directly, the neural network 414 can determine whether an event of interest has occurred by processing the received signal and send an analog output 416 corresponding to whether an event of interest has occurred, as described above in FIG. 1.

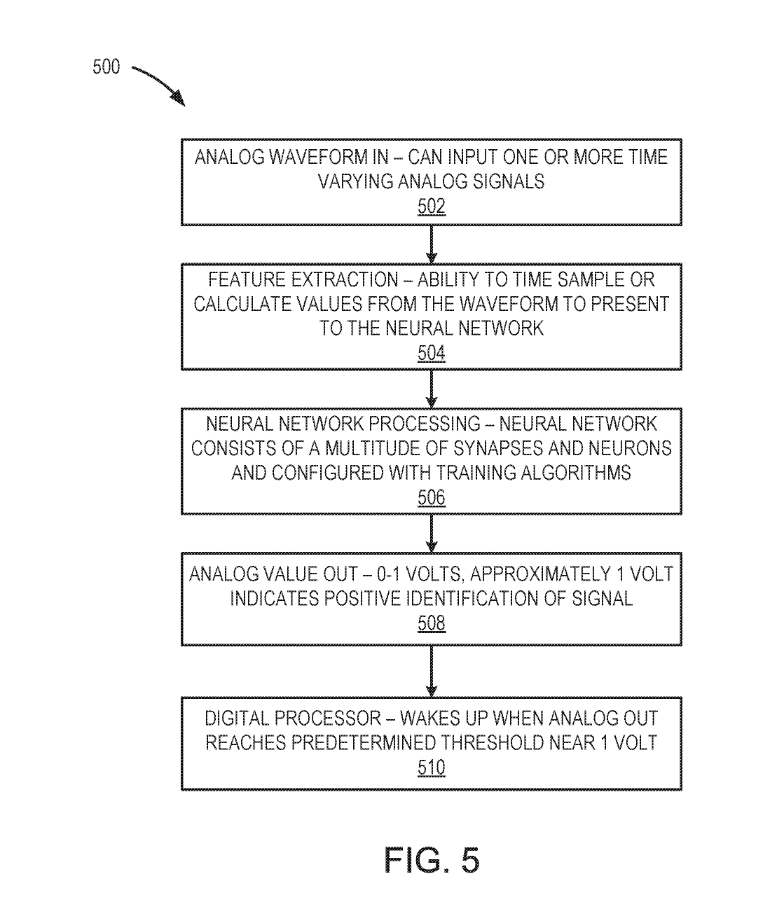

FIG. 5 is a flow diagram depicting the process 500 of the illustrative analog neural network 402 depicted in FIG. 4. As illustrated, the process 500 includes inputting an analog waveform in into the analog neural network 402 (block 502). The analog waveform may be one or more time varying analog signals. After the analog waveform is received, the analog neural network 402 may sample and hold different values of the analog waveform and/or extract one or more features from the analog waveform (block 504). Alternatively, the analog waveform may be directly passed to the neural network 402. Once either the analog waveform or a feature of the analog waveform is received by the neural network 414, the neural network 414 processes the received signal using the synapses and neurons that were configured using one or more training algorithms (e.g., the adaptive algorithms 116 depicted in FIG. 1) (block 506). If the neural network 414 processes the analog waveform or a feature of the analog waveform and determines one or both are not indicative of an event of interest, then the neural network outputs an analog value indicative of an event of non-interest (e.g., approximately 0V) (block 508). Alternatively, if the neural network 414 processes the analog waveform or a feature of the analog waveform and determines one or both are indicative of an event of interest, then the neural network outputs an analog value indicative of an event of interest (e.g., approximately 1V) (block 508). If the analog value output is indicative of an event of interest (e.g., approximately 1V), then a digital processor (e.g., the digital processor 108 depicted in FIG. 1) is configured to transition from a lower-power state to a higher-power state (block 510).

### Illustrative Applications of the General Systems and Methods

As noted above, the described systems and methods can advantageously be applied to power constrained embedded sensor applications that require extended battery life or power scavenging technologies. In addition, the described systems and methods are suitable for sensors that are used to continuously monitor and interpret data about events of interest which occur in relatively stable environments. The systems and methods are also well suited for applications where the sensor signal is noisy, signals of interest are relatively infrequent, and sampling rate is relatively high. The foregoing conditions can be readily addressed with the systems and methods described herein that use an analog neural network in communication with an as-needed digital processor.

### Illustrative Application—Medical Device

The described systems can be used for a variety of mobile health applications. Representative examples include monitoring and interpreting electroneurographic (ENG), electrocardiographic (ECG) for determining cardiac arrhythmias and/or other heart disorders, electroencephalographic (EEG) and/or electromyographic (EMG) signals for the control of prosthetics or other wirelessly connected devices. More particularly, the disclosed systems may be used to monitor for specific ENG waveforms, optionally in combination with signals from other bioelectric sources, including but not limited to EMG, ECG, EEG signals or artificial sensors for closed-loop neuromodulation applications. Applicable closed-loop neuromodulation methods include, but are not limited to, peripheral nerve, autonomic nerve, somatic nerve, vagus nerve, spinal cord, and deep brain stimulation. The disclosed neuromodulation devices have the potential to treat a variety of different disorders including, but not limited to, chronic pain, hypertension, Parkinson's disease, Alzheimer's disease, epilepsy, obesity, migraines, depression, and autoimmune disorders.

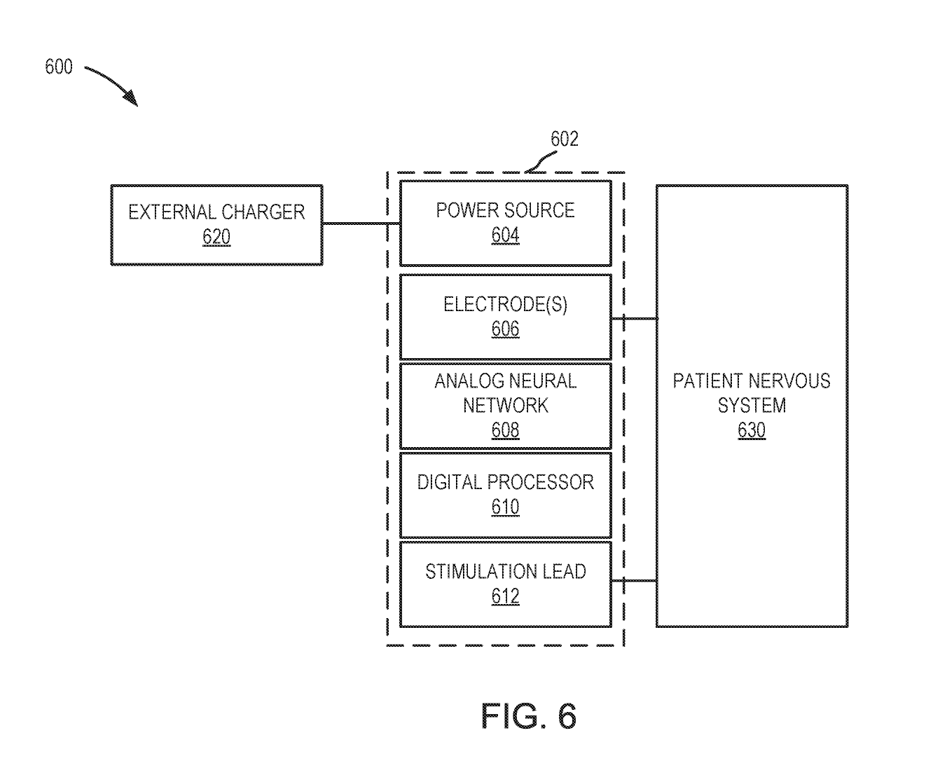

FIG. 6 is a block diagram depicting an illustrative example of a medical sensor signal processing system 600 using an analog neural network, in accordance with embodiments of this disclosure. The system 600 includes a medical device 602 that may be used in, for example, closed-loop neuromodulation applications. The medical device 602 includes a power source 604 (e.g., a battery) for powering the medical device 602. In embodiments, the power source 604 may be coupled intermittently to an external charger 620. The medical device 602 also includes one or more electrodes 606, communicatively coupled to a patient's nervous system 630, that are capable of sensing signals indicative of one or more physiological parameters associated with the patient nervous system 630. After sensing the signals (e.g., ENG signals) the electrodes 606 may provide signals associated with the sensed signals to an analog neural network 608. In embodiments, before the signals are received by the analog neural network 608, the sensed signals may be processed as described above. For example, one or more features may be extracted from the sensed signals and/or the signals may be converted to analog signals if they are not already analog signals.

In embodiments, the analog neural network 608 includes some or all of the same functionality as the analog neural network 106 discussed in FIG. 1 above. For example, the analog neural network 608 may be configured to determine an event of interest. When determining an event of interest, the analog neural network 608 outputs an analog signal to a digital processor 610 that causes the digital processor 610 to transition from a lower-power state to a higher-power state. After the digital processor 610 transitions to a higher-power state, in embodiments, the digital processor 610 may verify the determined event of interest. If the digital processor 610 verifies the event of interest, the medical device 602 may include a stimulation lead 612, operatively coupled to the patient nervous system 630. The stimulation lead 612 is configured to provide a stimulating pulse to the patient nervous system 630 when an event of interest is sensed by the electrodes 606. Due to this configuration, the device 602 may provide highly controlled, timely therapy with little energy expenditure by the device 602 when the patient nervous system 630 is not in need of a stimulating pulse, i.e., events of interest are not being detected by the electrodes 606.

In most neuromodulation scenarios, long periods of time will pass during which only normal signals are obtained. When an abnormal signal is detected however, it is critical that the system be able to accurately and appropriately react with additional signal processing, logical determinations and the potential application of stimulation. Furthermore, in embodiments featuring an internal battery as the power source 604, replacement of the battery is a somewhat invasive procedure. Therefore, use of a medical device 602 incorporating an analog neural network 608 to continuously or semi-continuously monitor normal signals which are only passed to the relatively higher power digital processor 610 and stimulation circuits 612 in the event of an initial neural signal abnormality classification can dramatically extend the life of the power source 604 (i.e., battery in this example) and provide a more robust overall medical device 602.

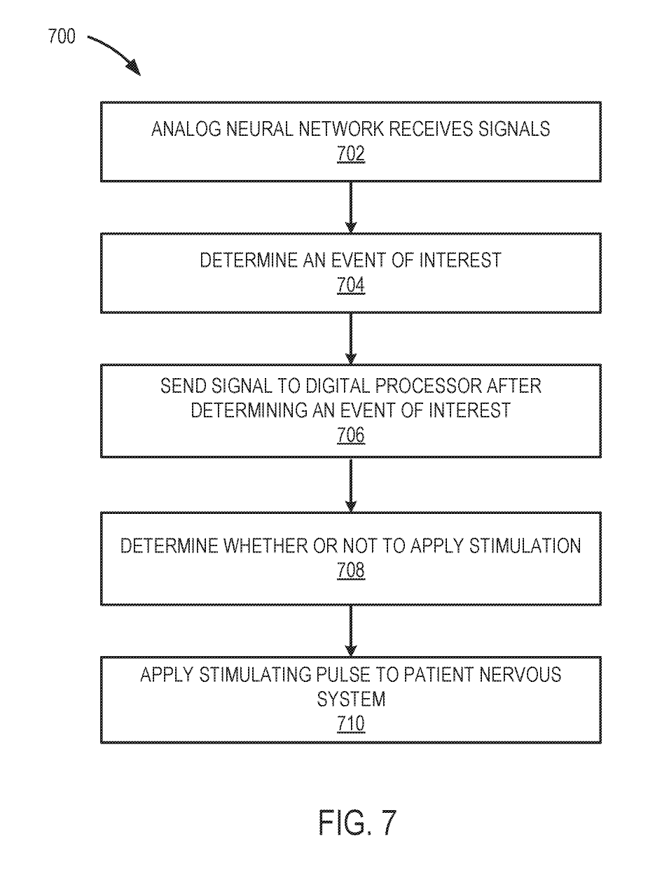

FIG. 7 is a flow diagram depicting the process 700 of the illustrative example of a sensor signal processing system depicted in FIG. 6. In the above neural stimulation example, the relatively low power analog neural network 608 continuously receives signals obtained by the electrodes 606 (block 702). For each of the analog signals received by the analog neural network 608, the analog neural network determines if an event of interest is present in the signals obtained by the electrodes 606 (block 704). In embodiments, an event of interest may correspond to the patient's nervous system being in an abnormal and/or diseased state. After determining an event of interest, the analog neural network 608 will send a signal to the digital processor 610 to convert from a lower-power state to a higher-power state (block 706). After converting from a lower-power state to a higher-power state, the digital processor may determine whether it is appropriate to apply a stimulating pulse to the patient nervous system 730 (block 708). In embodiments, this may include verifying the determined event of interest. If it is determined that a stimulating pulse should be applied to the patient nervous system 630, the digital processor 610 can instruct the stimulating lead 612 to apply a stimulating pulse to the patient nervous system 630 (block 710).

### Illustrative Application—Machinery Including Rotating Parts

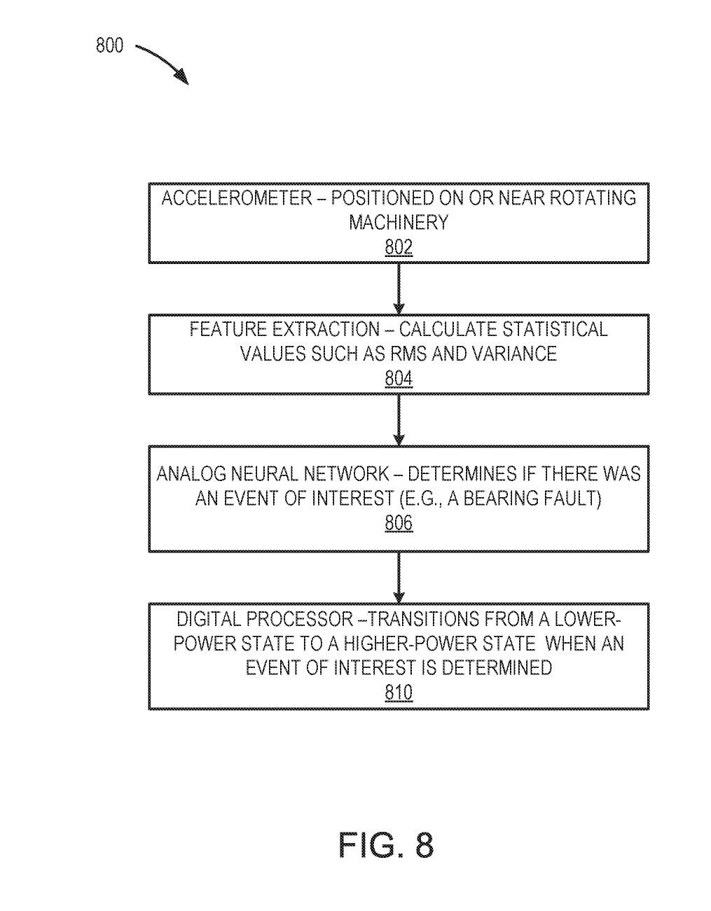

The systems and methods described herein may also be incorporated into machinery that includes one or more rotating parts. FIG. 8 is a flow diagram depicting a method 800 for using an analog neural network in a machine that includes one or more rotating parts, in accordance with embodiments of this disclosure. In this example, one or more accelerometers are positioned on or near one or more rotating parts of a machine (block 802). The accelerometers measure the rotation of the moving part. In embodiments, one or more features can be extracted from the output of the accelerometers, including but not limited to RMS, variance and/or other statistical values (block 804). The signals output by the accelerometers and/or features extracted from the signals output by the accelerometers are sent to the analog neural network. In embodiments, the feature extraction may be performed by the analog neural network, as described in FIG. 4 above. After receiving the signals and/or features extracted from the signals, the analog neural network will determine if the set of features represent an event of interest or an event of non-interest (block 806). In embodiments, an event of interest may be a particular type of bearing fault. If the analog neural network determines there is a fault, the circuit will output a signal to a digital processor. After which, the digital processor will transition from a lower-power state (e.g., a sleep and/or hibernation state) to a higher-power state (block 810). After transitioning to a higher-power state, the digital processor may perform further processing (e.g., verification of the event of interest), system control, data communication, and/or data storage. It is likely in this example that an event of interest (i.e., a bearing fault) would be infrequent, thus underscoring the advantage of low-power event detection which would allow the digital processor to remain in a lower-power state thereby possibly extending the useful life of the system.

### Illustrative Application—Engine Pressure

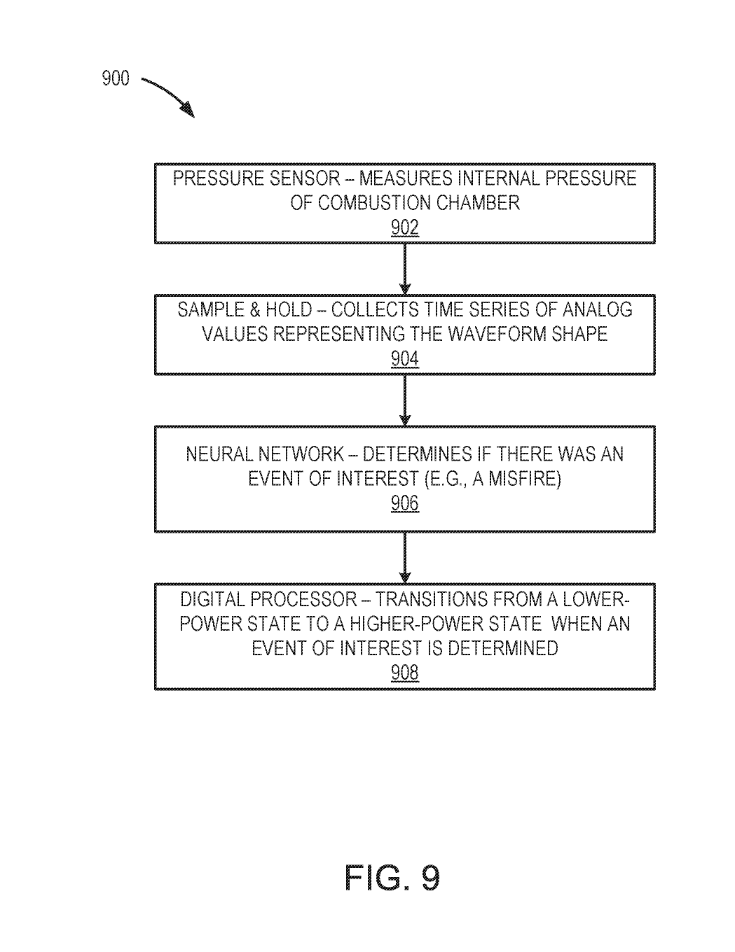

The systems and methods described herein may also be incorporated into engines. FIG. 9 is a flow diagram depicting a method 900 for using an analog neural network in an engine, in accordance with embodiments of this disclosure. In this example, one or more pressure sensors are positioned operatively to measure the internal pressure of a combustion chamber of an engine. The pressure sensors measure the internal pressure of the combustion chamber and output signals indicative of the internal pressure (block 902). After which, the outputted signals are sampled and held so that a time series of analog values representing the waveform shape of the signal is collected (block 904). This may be performed using a sample and hold circuit (e.g., the sample and hold circuit 408 depicted in FIG. 4). The time series of values are then sent to the analog neural network for processing. In embodiments, the analog neural network may have some or all of the same functionality as the analog neural network 106 depicted in FIG. 1. After receiving the signals, the analog neural network determines if an event of interest has occurred (block 906). In embodiments, an event of interest may be a misfire of the combustion chamber. If an event of interest is detected, the analog neural network sends a signal indicating that an event of interest has been determined to a digital processor. After receiving the signal, the digital processor transitions from a lower-power state (e.g., a sleep and/or hibernation state) to a higher-power state (block 908). In embodiments, upon transitioning to a higher-power state, the digital processor may perform control steps, additional data processing, data storage, or data communication. Since a combustion chamber misfiring happens somewhat infrequently for many vehicles, a vehicle incorporating the method 900 likely requires less power than if a digital processor would constantly be determining whether a misfire has occurred.

The systems and methods described herein can also be used for context awareness applications such as the detection of patterns in movement, sound, or light in mobile electronics. These are only examples, though, and not meant to be limiting.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Accordingly, the scope of the present disclosure is intended to embrace all such alternatives, modifications, and variations as fall within the scope of the claims, together with all equivalents thereof.

What is claimed is:

1. A sensor signal processing system comprising:
an analog neural network communicatively coupled to at least one sensor, the analog neural network being configured to:
receive a plurality of analog signals, the plurality of analog signals being associated with a plurality of sensor signals output by the at least one sensor;
determine an analog signal of the plurality of analog signals that is indicative of an event of interest; and
generate an activation signal in response to determining an analog signal is indicative of an event of interest; and
a digital processor communicatively coupled to the analog neural network, the digital processor being configured to:
receive the activation signal; and
transition to a higher-power state from a lower-power state in response to the activation signal.

2. The system of claim 1, further comprising at least one feature extraction circuit communicatively coupled to the at least one sensor and the analog neural network, the at least feature extraction circuit being configured to:
receive the plurality of sensor signals;
extract one or more features from each of the plurality of sensor signals; and
send the one or more features to the analog neural network, the one or more features being the plurality of analog signals.

3. The system of claim 2, wherein to extract one or more features, the at least one feature extraction circuit is configured to extract at least one of: a root-mean-square and a variance.

4. The system of claim 1, the analog neural network being further configured to:
extract one or more features from each of the plurality of analog signals; and
determine an analog signal of the plurality of analog signals that is indicative of an event of interest using the extracted one or more features.

5. The system of claim 1, further comprising: a memory device communicatively coupled to the analog neural network, the memory device being external to the analog neural network and being configured to:
store a plurality of weights used by the analog neural network to determine an analog signal of the plurality of analog signals that is indicative of an event of interest.

6. The system of claim 5, the digital processor being further configured to:
configure the plurality of weights using at least one of: a back-propagation algorithm and a weight perturbation algorithm.

7. The system of claim 1, further comprising the at least one sensor, wherein the at least one sensor is configured to sense at least one of: speed, velocity, linear acceleration, rotation, magnetic field strength, magnetic field direction, pressure, light, temperature, humidity, moisture, one or more chemicals and one or more physiological parameters.

8. The system of claim 7, wherein the plurality of sensor signals are indicative of at least one physiological parameter of a patient, the digital processor being further configured to: send a signal to a stimulation device after the analog neural network determines an analog signal is indicative of an event of interest, the sent signal initiating the stimulation device to apply a stimulating signal to the patient.

9. The system of claim 7, wherein the stimulation device is a neuromodulation device and the stimulating signal is a neural stimulating signal.

10. The system of claim 7, wherein the plurality of sensor signals are indicative of at least one of a linear acceleration and a rotation of a bearing, the digital processor being further configured to: send a signal to an interface in response to the analog neural network determining an analog signal is indicative of an event of interest, the sent signal indicating a fault in the bearing.

11. The system of claim 7, wherein the plurality of sensor signals are indicative of a pressure of a combustion chamber, the digital processor being further configured to: send a signal to an interface in response to the analog neural network determining an analog signal is indicative of an event of interest, the sent signal indicating a misfire of the combustion chamber.

12. The system of claim 1, wherein the digital processor is further configured to verify an analog signal is indicative of an event of interest in response to transitioning to the higher-power state from the lower-power state.

13. A method of processing a sensor signal, the method comprising:
receiving, by an analog neural network, a plurality of analog signals, the plurality of analog signals being associated with a plurality of sensor signals output by at least one sensor;
determining, by the analog neural network, an analog signal of the plurality of analog signals that is indicative of an event of interest; and
sending, by the analog neural network, an activation signal to a digital processor for each analog signal that is determined to be indicative of an event of interest, the activation signal initiating a transition of the digital processor to a high-power state from a lower-power state.

14. The method of claim 13, further comprising:
extracting, by a feature extraction circuit, one or more features from each of the plurality of sensor signals; and
determining an analog signal of the plurality of analog signals that is indicative of an event of interest using the one or more features.

15. The method of claim 14, wherein extracting one or more features comprises extracting at least one of: a root-mean square and a variance from each of the plurality of sensor signals.

16. The method of claim 13, wherein the plurality of sensor signals are indicative of at least one physiological parameter of a patient, the method further comprising: sending a signal, by the digital processor, to a stimulation device for each analog signal that is determined to be indicative of an event of interest, the sent signal initiating the stimulation device to apply a stimulating signal to the patient.

17. The system of claim 13, wherein the plurality of sensor signals are indicative of at least one of a linear acceleration and a rotation of a bearing, the method further comprising: sending a signal, by the digital processor, to an interface for each analog signal that is determined to be indicative of an event of interest, the sent signal indicating a fault in the bearing.

18. The system of claim 13, wherein the plurality of sensor signals are indicative of a pressure of a combustion chamber, the method further comprising: sending a signal, by the digital processor, to an interface for each analog signal that is determined to be indicative of an event of interest, the sent signal indicating a misfire of the combustion chamber.

19. A circuit comprising:
at least one sensor input communicatively coupled to at least one sensor output of at least one sensor;
at least one memory input communicatively coupled to an external memory device;
at least one digital processor output communicatively coupled to at least one digital processor input of a digital processor;
an analog neural network being configured to:
receive, via the at least one sensor input, a plurality of analog signals, the plurality of analog signals being associated with a plurality of sensor signals output by the at least one sensor;
load, via the at least one memory input, a plurality of weights;
determine an analog signal of the plurality of analog signals that is indicative of an event of interest using the plurality of weights; and
send, via the at least one digital processing output, an activation signal to the digital processor in response to determining an analog signal is indicative of an event of interest, the activation signal initiating a transition of the digital processor to a higher-power state from a lower-power state.

20. The circuit of claim 19, wherein the at least one sensor input is communicatively coupled to the at least one sensor output via at least one feature extraction circuit, the at least one feature extraction circuit being configured to:
receive the plurality of sensor signals;
extract one or more features from each of the plurality of sensor signals, the one or more features being at least one of: a root-mean-square and a variance; and
send the one or more features to the analog neural network via the at least one sensor input, the one or more features being the plurality of analog signals.
